(19) United States
(12) Patent Application Publication
(10) Pub. No.: US 2026/0088694 A1
(43) Pub. Date: Mar. 26, 2026

(54) RAPID MOTION CONTROL METHOD FOR RANDOM COMBINATIONS OF SIDE-BY-SIDE SEAMLESSLY FITTING GROUP OF SLIDE PLATES

(71) Applicants: TAIYUAN UNIVERSITY OF TECHNOLOGY, Taiyuan (CN); SHANGHAI SHAMIN INTELLIGENT TECHNOLOGY CO., LTD., Shanghai (CN); NORTH CHINA INSTITUTE OF SCIENCE AND TECHNOLOGY, Langfang (CN)

(72) Inventors: Ziming KOU, Taiyuan (CN); Guijun GAO, Taiyuan (CN); Juan WU, Taiyuan (CN); Jin WANG, Shanghai (CN); Jianguo LUO, Langfang (CN); Yuchen QIN, Taiyuan (CN); Pan LI, Langfang (CN); Wei WANG, Jinzhong (CN); Jiabao XUE, Jinzhong (CN); Yongcheng WANG, Lianyungang (CN); Jiang XU, Tonghua (CN)

(73) Assignees: TAIYUAN UNIVERSITY OF TECHNOLOGY, Taiyuan (CN); SHANGHAI SHAMIN INTELLIGENT TECHNOLOGY CO., LTD., Shanghai (CN); NORTH CHINA INSTITUTE OF SCIENCE AND TECHNOLOGY, Langfang (CN)

(21) Appl. No.: 18/992,205

(22) PCT Filed: Jun. 30, 2023
(86) PCT No.: PCT/CN2023/104401

§ 371 Date: Dec. 11, 2025

(30) Foreign Application Priority Data
Jun. 16, 2023 (CN) 202310718438.2

(51) Int. Cl. H02K 41/02; G05B 13/04; H02P 21/00

(52) U.S. Cl. CPC H02K 41/02; G05B 13/042; H02P 21/001

(57) ABSTRACT

A side-by-side seamlessly fitting group of slide plates includes a frame, a support rod is horizontally arranged on a top side of the frame, a plurality of support plates are rotatably connected to an outer side of the support rod, a permanent magnet linear synchronous motor is arranged on a top surface of each support plate, a linear slide rail is arranged on a top surface of the permanent magnet linear synchronous motor, a slider is slidably connected to an outer side of the linear slide rail, a mounting plate and a slide plate are arranged on a top surface of the slider in sequence, sides of two adjacent ones of the slide plates seamlessly fit to each other, and a bent end of the mounting plate extends to a side surface of the permanent magnet linear synchronous motor and is threadedly connected to a connecting plate.

### CROSS-REFERENCE TO THE RELATED APPLICATIONS

This application is the national phase entry of International Application No. PCT/CN2023/104401, filed on Jun. 30, 2023, which is based upon and claims priority to Chinese Patent Application No. 202310718438.2, filed on Jun. 16, 2023, the entire contents of which are incorporated herein by reference.

### TECHNICAL FIELD

The present disclosure belongs to the technical field of mechanical automation control, and in particular, relates to a rapid motion control method for random combinations of a side-by-side seamlessly fitting group of slide plates.

### BACKGROUND

Automation control technologies are widely applied in industry, agriculture, military, scientific research, transportation, commerce, medical treatment, services, families, and other fields. The use of automation technologies can not only free people from heavy physical labor, some mental labor, and harsh and dangerous working environments, but also greatly improve labor productivity.

A utility model patent with the publication number of CN 217832522 U discloses a welding tilter for offshore platform spud legs, which relates to the technical field of welding. The welding tilter for offshore platform spud legs includes a bottom plate, two support plates, a support platform, a fixed plate, a rotating shaft, a disc, and a servo motor. The support platform is fixedly mounted above the bottom plate through the two support plates. The fixed plate is fixedly mounted on an upper side of the support platform. The rotating shaft is rotatably mounted on the fixed plate. The disc is fixedly mounted on a right end of the rotating shaft, a clamping device is arranged on the disc, and a left end of the rotating shaft is connected to an output end of the servo motor. The servo motor is fixedly mounted on the fixed plate. Support wheels for holding the middle part of a spud leg are respectively mounted on a plurality of reciprocating slide plate mechanisms, which include a plurality of slide plates, the support wheels, a movable plate, a rotary shaft, a circular plate, a lifting device, and a moving device. A drive motor is turned on to propel a first lead screw to rotate, drawing two sliders away from each other. The two sliders cause two round wheels to move away from each other through two connecting plates. The two round wheels raise a lifting plate through two inclined blocks. The lifting plate raises the support wheels through the slide plates till upper ends of the support wheels are tightly pressed against a lower side of the spud leg, so that the middle part of the spud leg is held by the support wheels. The servo motor is turned on to drive the disc through the rotating shaft, causing the spud leg to rotate. The spud leg forces the rotary shaft and a friction wheel to rotate through the circular plate till a sand hole on the spud leg is presented at the upper side. Then, a screw rod is rotated to drive a friction disc to descend till a lower end of the friction disc contacts and is tightly pressed against an upper end of the friction wheel. After that, an external welding device is used to repair the sand hole on the spud leg by welding. During the welding process of the spud leg, the right end of the spud leg is held by a clamping device on the circular plate and the middle part of the spud leg is held by the support wheels, so that the bending stress in the spud leg is reduced, the deformation of the spud leg is reduced, and the reliability of the welding process is improved. Meanwhile, since the distance between the disc and the circular plate is adjustable, spud legs of different lengths can be clamped, which has few limitations and is convenient to use and highly practical.

A utility model patent with the publication number of CN 215395776 U discloses a floor core board threading machine, which relates to the technical field of bottom plate processing. The floor core board threading machine includes a base, a plurality of pillars, a plurality of reinforcement members, a top plate, a plurality of slide plates, a plurality of slide sleeves, a plurality of first hydraulic cylinders, a plurality of telescopic columns, a plurality of springs, a pressing frame, a pressing plate, a plurality of tension springs, a cutting device, and a conveying device. Boards to be cut are placed on the conveying device, and the first hydraulic cylinders are turned on to push downward the slide plates, so that the telescopic columns force the pressing frame to move downward, thereby pressing and fixing the boards on the conveying device at the same time. The fixed boards are then cut and grooved by the cutting device. The pressing plate is provided to enhance the effect of fixing a plurality of boards at the same time, reduce the shaking of the boards during cutting, increase the cutting accuracy, reduce the workload of personnel in fixing operations, and improve the working efficiency of the device. The cutting device includes a slider, a fixing member, a lead screw, a first motor, a second hydraulic cylinder, and a cutting mechanism. The first motor is turned on to drive the lead screw to rotate, causing the slider to move left and right. The slider drives the cutting mechanism through the second hydraulic cylinder to cut and groove the boards fixed on the conveying device, thereby improving the processing efficiency and stability of board grooving. The telescopic length of the second hydraulic cylinder is controlled to drive the cutting mechanism to move up and down, so that the grooving depth is controlled, thereby improving the accuracy of the device in controlling different grooving depths, reducing the limitations of the device in use, and improving the practicality of the device.

A utility model patent with the publication number of CN 217136036 U discloses a multifunctional vegetable seeder, which relates to the technical field of vegetable planting. The multifunctional vegetable seeder includes a moving vehicle, a seed box, a motor A, a rotating shaft, a rotary shaft, a first sprocket, a second sprocket, a chain, a plurality of seed-drop pipes, a plurality of sowing pipes, a plurality of valves, a plurality of slide plates, a plurality of plowshares, and a lifting device. The lifting device includes a drive motor, a connecting frame, a lead screw, a lifting block, a support plate, and a holding plate. The drive motor and the connecting frame are fixedly mounted on the moving vehicle, the lead screw is rotatably mounted on the connecting frame, an upper end of the lead screw is connected to an output end of the drive motor, and the lead screw is in threaded connection with the lifting block. The support plate and the holding plate are fixedly mounted on left and right sides of the lifting block respectively, the slide plates are fixedly mounted on the support plate, and the sowing pipes are fixedly mounted on the holding plate. The drive motor is turned on to propel the lead screw to rotate. The rotating lead screw forces the support plate and the holding plate to descend through the lifting block. The support plate brings the slide plates to descend, causing the plowshares to descend till they are inserted into the ground by a suitable depth. Since the height of the plowshares is adjustable, they can plow different depths of furrows in the land according to the varieties of vegetable seeds, which is convenient to use, has few limitations, and is highly practical.

In the above patents, reciprocating slide plate devices are used to achieve automation and require less manpower in the fields of welding, bottom plate processing, vegetable planting, and so on. They improve the labor productivity, reduce the production costs, have simple structures, and are easy to implement. However, in the process of driving the slide plates to move back and forth by means of the drive motor and the ball screw, due to the existence of the intermediate transmission mechanism, the transmission chain is long and the transmission gap is large, which greatly limits the working efficiency of the equipment and makes it impossible to achieve quick response of the slide plate mechanisms in various automated production lines. The use of cylinders to realize the up and down movement of the slide plates results in a complex equipment structure and high resource consumption.

### SUMMARY

A rapid motion control method for random combinations of a side-by-side seamlessly fitting group of slide plates is provided to solve the above problems in the prior art.

A side-by-side seamlessly fitting group of slide plates includes a frame, a support rod is horizontally arranged on a top side of the frame, a plurality of support plates are rotatably connected to an outer side of the support rod, a permanent magnet linear synchronous motor is arranged on a top surface of each of the plurality of support plates, a linear slide rail is arranged on a top surface of the permanent magnet linear synchronous motor, a slider is slidably connected to an outer side of the linear slide rail, a mounting plate is arranged on a top surface of the slider, a respective slide plate of the slide plates is threadedly connected to a top surface of the mounting plate and sides of two adjacent ones of the slide plates seamlessly fit to each other, a bent end of the mounting plate extends to a side surface of the permanent magnet linear synchronous motor and is threadedly connected to a connecting plate, the connecting plate is fixedly connected to a side surface of a mover of the permanent magnet linear synchronous motor, a grating ruler is provided at a bottom side of the permanent magnet linear synchronous motor, an end of the connecting plate away from the slider extends to a bottom side of the grating ruler and is provided with a light transmission hole, and an adjusting member for adjusting an angle of the slide plates is arranged on the top side of the frame.

Preferably, stop blocks are respectively arranged at two ends of the permanent magnet linear synchronous motor, a side of each of the stop blocks closer to the permanent magnet linear synchronous motor is fixedly connected to a respective end of the linear slide rail, a side of each of the stop blocks closer to the slider is provided with a rubber block, and the rubber block is adapted to the linear slide rail.

Preferably, the linear slide rail is provided with linear grooves along a length direction on two sides of the linear slide rail, the slider is provided with ridges on two sides of an inner wall of the slider, and the ridges are slidably connected to the linear grooves respectively.

Preferably, the adjusting member includes wedge grooves respectively provided on bottom surfaces of the slide plates, wedge blocks are slidably connected inside the wedge grooves respectively, bottom surfaces of the wedge blocks respectively extend out of the wedge grooves and are arranged on a strip plate, two hydraulic rods are rotatably connected to the top side of the frame, and an output end of each of the two hydraulic rods is fixedly connected to a bottom surface of the strip plate.

A fuzzy active disturbance rejection controller is provided, and the fuzzy active disturbance rejection controller is designed by a design method including the following steps:
step 1: specifying an input to be manipulated of a controlled system being a set mover speed v of a permanent magnet linear synchronous motor and an output of the controlled system being a q-axis current iq* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with nonlinear state error feedback (NLSEF) in the fuzzy active disturbance rejection controller, and adjusting online parameters of the NLSEF to implement a quick response of a group of slide plates.

Preferably, the mathematical model of the permanent magnet linear synchronous motor in a d-q-axis rotating coordinate system in the step 2 is:

$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$

an electromagnetic thrust equation is:

$${F}_{e} = \frac{3 π}{2 τ} {n}_{p} [ {ψ}_{f} {i}_{q} + ( {L}_{sd} - {L}_{sq} ) {i}_{d} {i}_{q} ]$$

an equation of motion is:

$${F}_{e} - {F}_{L} = M \frac{dv}{dt} + {B}_{m} v$$

where Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is total system disturbance; M is mover mass; and Bₘ is a viscous friction coefficient.

A control method for a side-by-side seamlessly fitting group of slide plates is provided, including the following steps:
S1: obtaining a tracking signal v₁ after tracking differentiator (TD) transition of vᵣ of a permanent magnet linear synchronous motor, and extracting a first-order differential signal v₂ to implement a quick motion response of the slide plates;
S2: using an extended state observer (ESO) to estimate in real time a system operating state and obtain observed values of a system disturbance including an internal disturbance y₁ and an external system load disturbance y₃, where the internal disturbance y₁ is caused by changes in temperature, resistance, and inductance of the permanent magnet linear synchronous motor;
S3: comparing v₁, v₂ respectively with an estimated value of y₁ obtained by the ESO and a differential signal y₂ based on a q-axis current i_{q} of the permanent magnet linear synchronous motor to obtain error signals e₁ and e₂;
S4: processing by the ESO an external load on the controlled object vᵣ to obtain a real-time estimated value of y₃ of an external system disturbance, using y₃ to compensate for a disturbance of a control value u by an active feedback through u=u₀−(y₃+f0(y₁,y₂))/b0, and forming a feedback structure with automatic compensation for the system disturbance to realize a dynamic linearization of an uncertain system; and
S5: simultaneously inputting the error signals e₁ and e₂ into a fuzzy controller to obtain optimal parameters of NLSEF, and inputting the optimal parameters into the NLSEF to obtain a control value u₀ of i_{q} during an operation and compensate for various disturbances,
where vᵣ is a set output speed of the permanent magnet linear synchronous motor; v₁ is a tracking signal of vᵣ; v₂ is a differential signal of vᵣ; u₀ is a control value of i_{q} during a system operation; u is a compensated control value; y₁ is a tracking signal of v; v is a real-time mover speed of the permanent magnet linear synchronous motor collected by a rotary encoder; y₂ is a differential signal of y₁; y₃ is an observed value of the external system load disturbance; and f₀(y₁,y₂) is known internal system disturbance.

Preferably, in the steps S1 to S5, a control system of multiple permanent magnet linear synchronous motors connected in parallel receives an instruction signal from a host computer, and operating states of the multiple permanent magnet linear synchronous motors are independent of each other.

In view of the above, the present disclosure has the following advantages.
1. The permanent magnet linear synchronous motor drives the slider to slide back and forth along the linear slide rail, causing the slide plate to reciprocate linearly in sync. It overcomes problems such as long drive chain, low transmission efficiency, and poor working stability in the linear motion process of a driven element, which is carried out by a conventional rotating motor with a transmission mechanism composed of chains, gears, and other components.
2. The strip plate is pushed by the hydraulic rods, causing the wedge blocks to slide in the wedge grooves at the bottom surfaces of the slide plates, so that the slide plates rotate to have their angles adjusted and the universality of the group of slide plates is improved.
3. To cope with thrust fluctuations caused by the fact that the permanent magnet linear synchronous motor is directly connected to a load and is sensitive to load changes, a speed loop regulator of the permanent magnet linear synchronous motor is improved by designing a fuzzy active disturbance rejection controller. Therefore, vector control and fuzzy active disturbance rejection control strategies are integrated, the advantages of fuzzy control and active disturbance rejection control are combined, and fuzzy rules are used to compensate for NLSEF. By inputting a tracking error signal and its differential signal into the fuzzy active disturbance rejection controller, active disturbance rejection control parameters are modified online with the fuzzy control rules to meet the requirements on the active disturbance rejection control parameters during the reciprocating motion of the slide plates. The controller has a simple structure and can cope with problems such as input signal smoothing, motion disturbance, and difficulty in matching parameters caused by strict requirements on the accuracy, stability, and quick response of the motion system, so that the system has higher accuracy and robustness.
4. The strategy of using multiple permanent magnet linear synchronous motors to concurrently control a group of slide plates is adopted. After an instruction is sent to the controlled permanent magnet linear synchronous motors, the permanent magnet linear synchronous motors operate according to the instruction without interfering with each other. The permanent magnet linear synchronous motors are independent of each other and have the advantages of simple control method and control principle, no delay in start and stop signals, and so on.
5. The vector control and the fuzzy active disturbance rejection control of a single permanent magnet linear synchronous motor are highly integrated with the concurrent control strategy of multiple motors, achieving a control effect that the slide plates do not interfere with each other and any combination of the slide plates can cooperate and move together. Therefore, the system has high positioning accuracy, simple mechanical structures, high efficiency and energy-saving characteristics, quick response, and high stability. Each slide plate can not only respond independently, but also form a group with any other slide plates for joint response. The random combinations of the slide plates can achieve quick response at various positions to meet the requirements under different loads and effectively eliminate the impact of the load on the robustness of the entire system.

### BRIEF DESCRIPTION OF THE DRAWINGS

FIG. 1 is a schematic structural diagram of the present disclosure.

FIG. 2 is a schematic structural diagram of a single slide plate module according to the present disclosure.

FIG. 3 is an enlarged view of A in FIG. 2 of the present disclosure.

FIG. 4 is a structural diagram of fuzzy active disturbance rejection control according to the present disclosure.

FIG. 5 is a structural diagram of concurrent control on a group of slide plates according to the present disclosure.

Reference numerals: 1. frame; 2. support rod; 3. support plate; 4. permanent magnet linear synchronous motor; 5. linear slide rail; 6. slider; 7. mounting plate; 8. slide plate; 9. connecting plate; 10. grating ruler; 11. light transmission hole; 12. stop block; 13. rubber block; 14. linear groove; 15. ridge; 16. wedge groove; 17. wedge block; 18. strip plate; 19. hydraulic rod.

### DETAILED DESCRIPTION OF THE EMBODIMENTS

In the following description, numerous specific details are given in order to provide a more thorough understanding of the present disclosure. However, it is apparent to persons skilled in the art that the present disclosure can be implemented without one or more of these details. In other examples, some technical features that are well known in the art are not described in order to avoid confusion with the present disclosure.

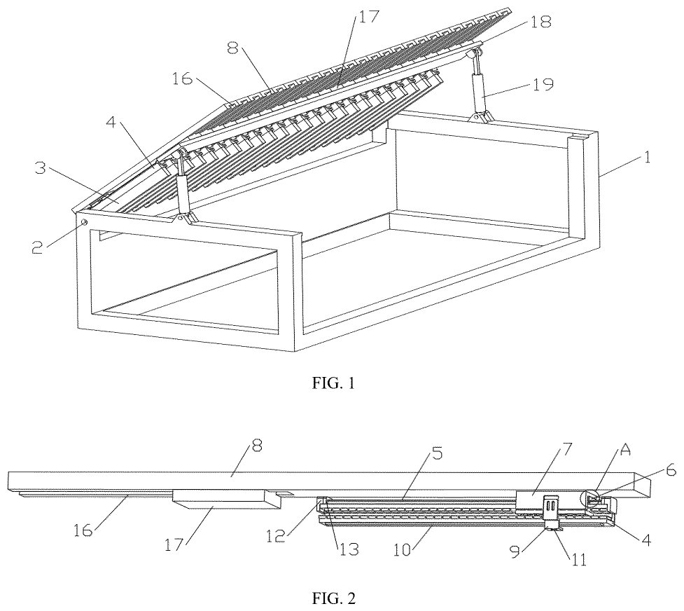

As shown in FIG. 1 and FIG. 2, a side-by-side seamlessly fitting group of slide plates includes a frame 1. A support rod 2 is horizontally arranged on a top side of the frame 1. A plurality of support plates 3 are rotatably connected to an outer side of the support rod 2. A permanent magnet linear synchronous motor 4 is arranged on a top surface of each of the plurality of support plates 3. A linear slide rail 5 is arranged on a top surface of the permanent magnet linear synchronous motor 4. A slider 6 is slidably connected to an outer side of the linear slide rail 5. A mounting plate 7 is arranged on a top surface of the slider 6. A respective slide plate 8 of the slide plates 8 is threadedly connected to a top surface of the mounting plate 7, and sides of two adjacent ones of the slide plates 8 seamlessly fit to each other. A bent end of the mounting plate 7 extends to a side surface of the permanent magnet linear synchronous motor 4 and is threadedly connected to a connecting plate 9. The connecting plate 9 is fixedly connected to a side surface of a mover of the permanent magnet linear synchronous motor 4. A grating ruler 10 is provided at a bottom side of the permanent magnet linear synchronous motor 4. An end of the connecting plate 9 away from the slider 6 extends to a bottom side of the grating ruler 10 and is provided with a light transmission hole 11. An adjusting member for adjusting an angle of the slide plates 8 is arranged on the top side of the frame.

As shown in FIG. 1 and FIG. 2, a position controller processes the difference between a grating feedback position signal of the permanent magnet linear synchronous motor 4 and a position setting instruction and outputs a speed instruction. A speed controller processes the difference between a speed feedback value and the speed instruction and outputs a current instruction. A current controller processes the difference between a current feedback value and the current setting instruction and outputs a signal to an inverter. A three-phase alternating current is input into a primary winding of the permanent magnet linear synchronous motor 4 to generate a traveling wave magnetic field in the air gap. The traveling wave magnetic field interacts with the excitation magnetic field generated by a permanent magnet to form an electromagnetic force, enabling the mover to perform linear motion. The mover drives the slider 6 to slide back and forth along the linear slide rail 5, causing the slide plate 8 to reciprocate linearly in sync. It overcomes problems such as long drive chain, low transmission efficiency, and poor working stability in the linear motion process of a driven element, which is carried out by a conventional rotating motor with a transmission mechanism composed of chains, gears, and other components.

As shown in FIG. 2, stop blocks 12 are respectively arranged at two ends of the permanent magnet linear synchronous motor 4. A side of each of the stop blocks 12 closer to the permanent magnet linear synchronous motor 4 is fixedly connected to a respective end of the linear slide rail 5. A side of each of the stop blocks 12 closer to the slider 6 is provided with a rubber block 13, and the rubber block 13 is adapted to the linear slide rail 5. The slider 6 is limited by the stop blocks 12, and the rubber pads playing a role of buffer protection prevent the slider 6 from directly contacting the stop blocks 12.

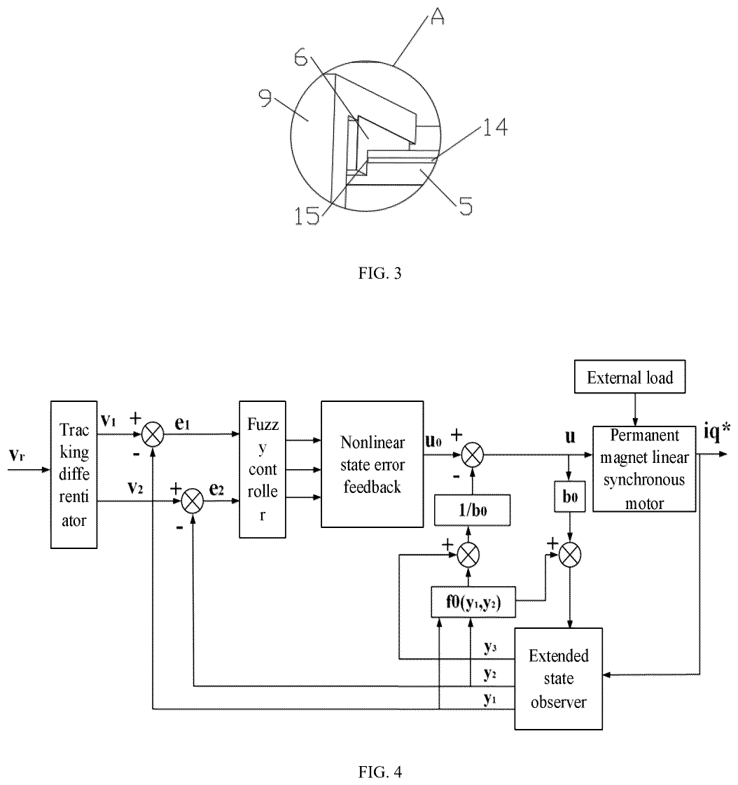

As shown in FIG. 3, the linear slide rail 5 is provided with linear grooves 14 along a length direction on two sides of the linear slide rail 5, and the slider 6 is provided with ridges 15 on two sides of an inner wall of the slider 6. The ridges 15 are slidably connected to the linear grooves 14 respectively, preventing the slider 6 from detaching from the linear slide rail 5.

As shown in FIG. 1 and FIG. 2, the adjusting member includes wedge grooves 16 respectively provided on bottom surfaces of the slide plates 8, and wedge blocks 17 are slidably connected inside the wedge grooves 16 respectively. Bottom surfaces of the wedge blocks 17 respectively extend out of the wedge grooves 16 and are arranged on a strip plate 18. Two hydraulic rods 19 are rotatably connected to the top side of the frame, and an output end of each of the two hydraulic rods 19 is fixedly connected to a bottom surface of the strip plate 18. The strip plate 18 is pushed by the two hydraulic rods 19, causing the wedge blocks 17 to slide in the wedge grooves 16 at the bottom surfaces of the slide plates 8 respectively, so that the slide plates 8 rotate to have their angles adjusted and the universality of the group of slide plates 8 is improved.

As shown in FIG. 4, the direct drive mode of the permanent magnet linear synchronous motor to achieve zero transmission causes uncertain factors such as load changes, nonlinear friction, thrust fluctuations, and external interference to directly act on the mover of the permanent magnet linear synchronous motor, which deteriorates the position tracking accuracy of the permanent magnet linear synchronous motor. Therefore, a fuzzy active disturbance rejection controller is designed based on the permanent magnet linear synchronous motor to improve the position tracking accuracy of the permanent magnet linear synchronous motor. The design method includes the following steps.
Step 1: It is specified that an input to be manipulated of a controlled system is a set mover speed v of the permanent magnet linear synchronous motor and an output of the controlled system is a q-axis current iq* of the permanent magnet linear synchronous motor.
Step 2: A mathematical model of the permanent magnet linear synchronous motor is established to determine the order of the fuzzy active disturbance rejection controller.
Step 3: An interference signal of the controlled system is defined through various known and unknown components.
Step 4: A fuzzy logic is designed and is combined with NLSEF in the fuzzy active disturbance rejection controller, and parameters of the NLSEF are adjusted online to implement a quick response of the group of slide plates.

Specifically, the mathematical model of the permanent magnet linear synchronous motor in a d-q-axis rotating coordinate system in the step 2 is:

$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$

An electromagnetic thrust equation is:

$${F}_{e} = \frac{3 π}{2 τ} {n}_{p} [ {ψ}_{f} {i}_{q} + ( {L}_{sd} - {L}_{sq} ) {i}_{d} {i}_{q} ]$$

An equation of motion is:

$${F}_{e} - {F}_{L} = M \frac{dv}{dt} + {B}_{m} v$$

where Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is the number of pole pairs; F_{L} is total system disturbance; M is mover mass; and Bₘ is a viscous friction coefficient.

A control method for the side-by-side seamlessly fitting group of slide plates is described below. As shown in FIG. 4, the specific control process of the control method includes the following steps.
S1: A tracking signal v₁ is obtained after TD transition of vᵣ of the permanent magnet linear synchronous motor, and a first-order differential signal v₂ is extracted to implement a quick motion response of the slide plates.
S2: An ESO is used to estimate in real time the system operating state and obtain observed values of a system disturbance including an internal disturbance y₁ and an external system load disturbance y₃, where the internal disturbance y₁ is caused by changes in temperature, resistance, and inductance of the permanent magnet linear synchronous motor.
S3: v₁, v₂ are respectively compared with an estimated value of y₁ obtained by the ESO and a differential signal y₂ based on the q-axis current i_{q} of the permanent magnet linear synchronous motor to obtain error signals e₁ and e₂.
S4: An external load on the controlled object vᵣ is processed by the ESO to obtain a real-time estimated value of y₃ of an external system disturbance, y₃ is used to compensate for a disturbance of a control value u by an active feedback through u=u₀—(y₃+f0(y₁,y₂))/b0, and a feedback structure with automatic compensation for the system disturbance is formed to realize a dynamic linearization of an uncertain system.
S5: The error signals e₁ and e₂ are simultaneously input into a fuzzy controller to obtain optimal parameters of the NLSEF, and the optimal parameters are input into the NLSEF to obtain a control value u₀ of i_{q} during an operation and compensate for various disturbances.

vᵣ is a set output speed of the permanent magnet linear synchronous motor; v₁ is a tracking signal of vᵣ; v₂ is a differential signal of vᵣ; u₀ is a control value of i_{q} during a system operation; u is a compensated control value; y₁ is a tracking signal of v; v is a real-time mover speed of the permanent magnet linear synchronous motor collected by a rotary encoder; y₂ is a differential signal of y₁; y₃ is an observed value of the external system load disturbance; f₀(y₁,y₂) is a known internal system disturbance; and i_{q}* is a set q-axis current.

To cope with thrust fluctuations caused by the fact that the permanent magnet linear synchronous motor is directly connected to a load and is sensitive to load changes, a speed loop regulator of the permanent magnet linear synchronous motor is improved by designing a fuzzy active disturbance rejection controller in the above control method. Therefore, vector control and fuzzy active disturbance rejection control strategies are integrated, the advantages of fuzzy control and active disturbance rejection control are combined, and fuzzy rules are used to compensate for NLSEF. By inputting a tracking error signal and its differential signal into the fuzzy active disturbance rejection controller, active disturbance rejection control parameters are modified online with the fuzzy control rules to meet the requirements on the active disturbance rejection control parameters during the reciprocating motion of the slide plates. The controller has a simple structure and can cope with problems such as input signal smoothing, motion disturbance, and difficulty in matching parameters caused by strict requirements on the accuracy, stability, and quick response of the motion system, so that the system has higher accuracy and robustness.

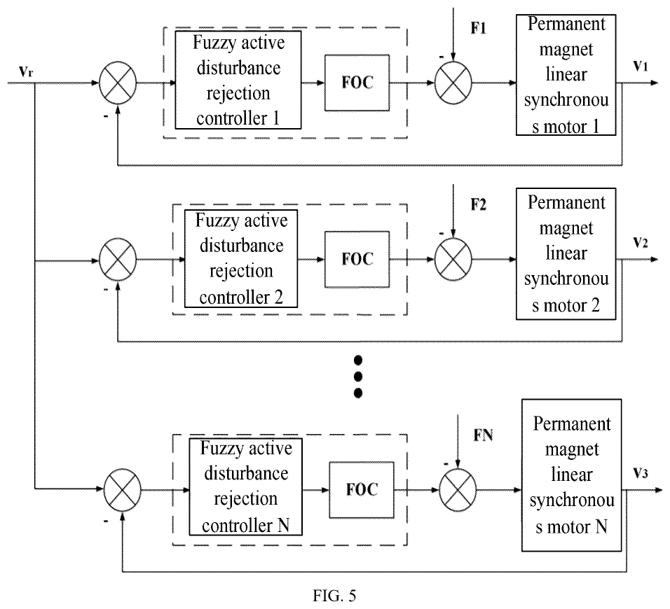

As shown in FIG. 5, in the steps S1 to S5, a control system of multiple permanent magnet linear synchronous motors connected in parallel receives an instruction signal from a host computer, and operating states of the multiple permanent magnet linear synchronous motors are independent of each other, realizing random combinations of the slide plates in motion and achieving a control effect that the slide plates do not interfere with each other and any combination of the slide plates can cooperate and move together. Therefore, the system has high positioning accuracy, simple mechanical structures, high efficiency and energy-saving characteristics, quick response, and high stability. Each slide plate can not only respond independently, but also form a group with any other slide plates for joint response. The random combinations of the slide plates can achieve quick response at various positions to meet the requirements under different loads and effectively eliminate the impact of the load on the robustness of the entire system. In FIG. 5, vᵣ is a speed instruction output by the position controller after processing the difference between the grating feedback position signal of the motor and the position setting instruction; and vᵢ, Fᵢ are a real-time speed and external system load disturbance of the i^{th} motor mover (i=1, 2, 3, . . . , N), respectively.

The preferred embodiments of the present disclosure have been described in detail above with reference to the accompanying drawings. However, the present disclosure is not limited to the specific details of the above embodiments. Various equivalent changes can be made to the technical solutions of the present disclosure within the scope of the technical concept of the present disclosure, and these equivalent changes all fall within the protection scope of the present disclosure.

What is claimed is:

1. A side-by-side seamlessly fitting group of slide plates, comprising a frame, wherein a support rod is horizontally arranged on a top side of the frame, a plurality of support plates are rotatably connected to an outer side of the support rod, a permanent magnet linear synchronous motor is arranged on a top surface of each of the plurality of support plates, a linear slide rail is arranged on a top surface of the permanent magnet linear synchronous motor, a slider is slidably connected to an outer side of the linear slide rail, a mounting plate is arranged on a top surface of the slider, a respective slide plate of the slide plates is threadedly connected to a top surface of the mounting plate, and sides of two adjacent ones of the slide plates seamlessly fit to each other, a bent end of the mounting plate extends to a side surface of the permanent magnet linear synchronous motor and is threadedly connected to a connecting plate, the connecting plate is fixedly connected to a side surface of a mover of the permanent magnet linear synchronous motor, a grating ruler is provided at a bottom side of the permanent magnet linear synchronous motor, an end of the connecting plate away from the slider extends to a bottom side of the grating ruler and is provided with a light transmission hole, and an adjusting member for adjusting an angle of the slide plates is provided on the top side of the frame.

2. The side-by-side seamlessly fitting group of slide plates according to claim 1, wherein stop blocks are respectively arranged at two ends of the permanent magnet linear synchronous motor, a first side of each of the stop blocks is adjacent to the permanent magnet linear synchronous motor and fixedly connected to a respective end of the linear slide rail, a second side of each of the stop blocks is adjacent to the slider and provided with a rubber block, and the rubber block is adapted to the linear slide rail.

3. The side-by-side seamlessly fitting group of slide plates according to claim 1, wherein the linear slide rail is provided with linear grooves along a length direction on two sides of the linear slide rail, the slider is provided with ridges-on two sides of an inner wall of the slider, and the ridges are slidably connected to the linear grooves respectively.

4. The side-by-side seamlessly fitting group of slide plates according to claim 1, wherein the adjusting member comprises wedge grooves respectively provided on bottom surfaces of the slide plates, wedge blocks are slidably connected inside the wedge grooves respectively, bottom surfaces of the wedge blocks respectively extend out of the wedge grooves and are arranged on a strip plate, two hydraulic rods are rotatably connected to the top side of the frame, and an output end of each of the two hydraulic rods is fixedly connected to a bottom surface of the strip plate-.

5. The side-by-side seamlessly fitting group of slide plates according to claim 1, further comprising a fuzzy active disturbance rejection controller, wherein the fuzzy active disturbance rejection controller is configured to control a position tracking accuracy of the permanent magnet linear synchronous motor by the following steps:
step 1: specifying an input to be manipulated of a controlled system being a set mover speed v of the permanent magnet linear synchronous motor and an output of the controlled system being a q-axis current i_{q}* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with nonlinear state error feedback (NLSEF) in the fuzzy active disturbance rejection controller, and adjusting online parameters of the NLSEF to implement a quick response of a group of slide plates.

6. The side-by-side seamlessly fitting group of slide plates according to claim 5, wherein the mathematical model of the permanent magnet linear synchronous motor in a d-q-axis rotating coordinate system in the step 2 is:
$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$
an electromagnetic thrust equation is:
$${F}_{e} - \frac{3 π}{2 τ} {n}_{p} [ {ψ}_{f} {i}_{q} + ( {L}_{sd} - {L}_{sq} ) {i}_{d} {i}_{q} ]$$
an equation of motion is:
$${F}_{e} - {F}_{L} = M \frac{dv}{dt} + {B}_{m} v$$
wherein Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is a total system disturbance; M is a mover mass; and Bₘ is a viscous friction coefficient.

7. A control method for the side-by-side seamlessly fitting group of slide plates according to claim 1, comprising the following steps:
S1: obtaining a tracking signal v₁ after tracking differentiator (TD) transition of vᵣ of the permanent magnet linear synchronous motor, and extracting a first-order differential signal v₂ to implement a quick motion response of the slide plates;
S2: using an extended state observer (ESO) to estimate in real time a system operating state and obtain observed values of a system disturbance comprising an internal disturbance y₁ and an external system load disturbance y₃, wherein the internal disturbance y₁ is caused by changes in temperature, resistance, and inductance of the permanent magnet linear synchronous motor;
S3: comparing v₁, v₂ respectively with an estimated value of y₁ obtained by the ESO and a differential signal y₂ based on a q-axis current i_{q} of the permanent magnet linear synchronous motor to obtain error signals e₁ and e₂;
S4: processing, by the ESO, an external load on the controlled object vᵣ to obtain a real-time estimated value of y₃ of an external system disturbance, using y₃ to compensate for a disturbance of a control value u by an active feedback through u=u₀−(y₃+f0(y₁,y₂)/b0, and forming a feedback structure with automatic compensation for the system disturbance to realize a dynamic linearization of an uncertain system; and
S5: simultaneously inputting the error signals e₁ and e₂ into a fuzzy controller to obtain optimal parameters of NLSEF, and inputting the optimal parameters into the NLSEF to obtain a control value u₀ of i_{q} during an operation and compensate for various disturbances,
wherein vᵣ is a set output speed of the permanent magnet linear synchronous motor; v₁ is a tracking signal of vᵣ; v₂ is a differential signal of vᵣ; u₀ is a control value of i_{q} during a system operation; u is a compensated control value; y₁ is a tracking signal of v; v is a real-time mover speed of the permanent magnet linear synchronous motor collected by a rotary encoder; y₂ is a differential signal of y₁; y₃ is an observed value of the external system load disturbance; and f₀(y₁,y₂) is a known internal system disturbance.

8. The control method according to claim 7, wherein in the steps S1 to S5, a control system of a plurality of permanent magnet linear synchronous motors connected in parallel receives an instruction signal from a host computer, and operating states of the plurality of permanent magnet linear synchronous motors are independent of each other.

9. The side-by-side seamlessly fitting group of slide plates according to claim 2, further comprising a fuzzy active disturbance rejection controller, wherein the fuzzy active disturbance rejection controller is configured to control a position tracking accuracy of the permanent magnet linear synchronous motor by the following steps:
step 1: specifying an input to be manipulated of a controlled system being a set mover speed v of the permanent magnet linear synchronous motor and an output of the controlled system being a q-axis current i_{q}* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with NLSEF in the fuzzy active disturbance rejection controller, and adjusting online parameters of the NLSEF to implement a quick response of a group of slide plates.

10. The side-by-side seamlessly fitting group of slide plates according to claim 3, further comprising a fuzzy active disturbance rejection controller, wherein the fuzzy active disturbance rejection controller is configured to control a position tracking accuracy of the permanent magnet linear synchronous motor by the following steps:
step 1: specifying an input to be manipulated of a controlled system being a set mover speed v of the permanent magnet linear synchronous motor and an output of the controlled system being a q-axis current i_{q}* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with NLSEF in the fuzzy active disturbance rejection controller, and adjusting online parameters of the NLSEF to implement a quick response of a group of slide plates.

11. The side-by-side seamlessly fitting group of slide plates according to claim 4, further comprising a fuzzy active disturbance rejection controller, wherein the fuzzy active disturbance rejection controller is configured to control a position tracking accuracy of the permanent magnet linear synchronous motor by the following steps:
step 1: specifying an input to be manipulated of a controlled system being a set mover speed v of the permanent magnet linear synchronous motor and an output of the controlled system being a q-axis current i_{q}* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with NLSEF in the fuzzy active disturbance rejection controller, and adjusting online parameters of the NLSEF to implement a quick response of a group of slide plates.

12. The side-by-side seamlessly fitting group of slide plates according to claim 9, wherein the mathematical model of the permanent magnet linear synchronous motor in a d-q-axis rotating coordinate system in the step 2 is:
$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$
an electromagnetic thrust equation is:
$${F}_{e} - \frac{3 π}{2 τ} {n}_{p} [ {ψ}_{f} {i}_{q} + ( {L}_{sd} - {L}_{sq} ) {i}_{d} {i}_{q} ]$$
an equation of motion is:
$${F}_{e} - {F}_{L} = M \frac{dv}{dt} + {B}_{m} v$$
wherein Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is a total system disturbance; M is a mover mass; and Bₘ is a viscous friction coefficient.

13. The side-by-side seamlessly fitting group of slide plates according to claim 10, wherein the mathematical model of the permanent magnet linear synchronous motor in a d-q-axis rotating coordinate system in the step 2 is:
$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$
an electromagnetic thrust equation is:
$${F}_{e} - \frac{3 π}{2 τ} {n}_{p} [ {ψ}_{f} {i}_{q} + ( {L}_{sd} - {L}_{sq} ) {i}_{d} {i}_{q} ]$$
an equation of motion is:
$${F}_{e} - {F}_{L} = M \frac{dv}{dt} + {B}_{m} v$$
wherein Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is a total system disturbance; M is a mover mass; and Bₘ is a viscous friction coefficient.

14. The side-by-side seamlessly fitting group of slide plates according to claim 11, wherein the mathematical model of the permanent magnet linear synchronous motor in a d-q-axis rotating coordinate system in the step 2 is:
$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$
an electromagnetic thrust equation is:
$${F}_{e} - \frac{3 π}{2 τ} {n}_{p} [ {ψ}_{f} {i}_{q} + ( {L}_{sd} - {L}_{sq} ) {i}_{d} {i}_{q} ]$$
an equation of motion is:
$${F}_{e} - {F}_{L} = M \frac{dv}{dt} + {B}_{m} v$$
wherein Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is a total system disturbance; M is a mover mass; and Bₘ is a viscous friction coefficient.

15. The control method according to claim 7, wherein in the side-by-side seamlessly fitting group of slide plates, stop blocks are respectively arranged at two ends of the permanent magnet linear synchronous motor, a first side of each of the stop blocks is adjacent to the permanent magnet linear synchronous motor and fixedly connected to a respective end of the linear slide rail, a second side of each of the stop blocks is adjacent to the slider and provided with a rubber block, and the rubber block is adapted to the linear slide rail.

16. The control method according to claim 7, wherein in the side-by-side seamlessly fitting group of slide plates, the linear slide rail is provided with linear grooves along a length direction on two sides of the linear slide rail, the slider is provided with ridges on two sides of an inner wall of the slider, and the ridges are slidably connected to the linear grooves respectively.

17. The control method according to claim 7, wherein in the side-by-side seamlessly fitting group of slide plates, the adjusting member comprises wedge grooves respectively provided on bottom surfaces of the slide plates, wedge blocks are slidably connected inside the wedge grooves respectively, bottom surfaces of the wedge blocks respectively extend out of the wedge grooves and are arranged on a strip plate, two hydraulic rods are rotatably connected to the top side of the frame, and an output end of each of the two hydraulic rods is fixedly connected to a bottom surface of the strip plate.

18. The control method according to claim 7, wherein the side-by-side seamlessly fitting group of slide plates further comprises a fuzzy active disturbance rejection controller, wherein the fuzzy active disturbance rejection controller is configured to control a position tracking accuracy of the permanent magnet linear synchronous motor by the following steps:
step 1: specifying an input to be manipulated of a controlled system being a set mover speed v of the permanent magnet linear synchronous motor and an output of the controlled system being a q-axis current i_{q}* of the permanent magnet linear synchronous motor;
step 2: establishing a mathematical model of the permanent magnet linear synchronous motor to determine an order of the fuzzy active disturbance rejection controller;
step 3: defining an interference signal of the controlled system through various known and unknown components; and
step 4: designing and combining a fuzzy logic with nonlinear state error feedback (NLSEF) in the fuzzy active disturbance rejection controller, and adjusting online parameters of the NLSEF to implement a quick response of a group of slide plates.

19. The control method according to claim 18, wherein the mathematical model of the permanent magnet linear synchronous motor in a d-q-axis rotating coordinate system in the step 2 is:
$$\{ \begin{matrix}\frac{{di}_{d}}{dt} = ( {u}_{d} - {R}_{s} {i}_{d} + {L}_{sq} {i}_{q} \frac{π}{τ} v ) / {L}_{sd} \\ \frac{{di}_{q}}{dt} = ( {u}_{q} - {R}_{s} {i}_{q} + {L}_{sd} {i}_{d} \frac{π}{τ} v - {ψ}_{f} \frac{π}{τ} v ) / {L}_{sq} \\ \frac{dv}{dt} = \frac{3 {n}_{p} π ( {L}_{sd} - {L}_{sq} )}{2 M τ} {i}_{d} {i}_{q} + \frac{3 {n}_{p} {πψ}_{f}}{2 M τ} - \frac{{F}_{L}}{M} - \frac{{B}_{m}}{M} v\end{matrix}$$
an electromagnetic thrust equation is:
$${F}_{e} - \frac{3 π}{2 τ} {n}_{p} [ {ψ}_{f} {i}_{q} + ( {L}_{sd} - {L}_{sq} ) {i}_{d} {i}_{q} ]$$
an equation of motion is:
$${F}_{e} - {F}_{L} = M \frac{dv}{dt} + {B}_{m} v$$
wherein Fₑ is an electromagnetic thrust; u_{d}, u_{q}, i_{d}, i_{q} are a d-axis voltage component, a q-axis voltage component, a d-axis current component, and a q-axis current component respectively; Rₛ is an armature winding resistance; v is a mover speed; L_{sd}, L_{sq} are a d-axis inductance and a q-axis inductance respectively; ψ_{f} is a permanent magnet flux linkage; τ is a permanent magnet pole pitch; nₚ is a number of pole pairs; F_{L} is a total system disturbance; M is a mover mass; and Bₘ is a viscous friction coefficient.

20. The control method according to claim 15, wherein in the steps S1 to S5, a control system of a plurality of permanent magnet linear synchronous motors connected in parallel receives an instruction signal from a host computer, and operating states of the plurality of permanent magnet linear synchronous motors are independent of each other.
